(19) United States
(12) Patent Application Publication
(10) Pub. No.: US 2006/0243396 A1
(43) Pub. Date: Nov. 2, 2006

(54) Non lift cord operated blind structure

(75) Inventor: Wen Ying Liang, Lugang Town (TW)

Correspondence Address: TROXELL LAW OFFICE PLLC, SUITE 1404, 5205 LEESBURG PIKE, FALLS CHURCH, VA, 22041, US

(73) Assignee: Ching Feng Home Fashions Co., Ltd.

(21) Appl. No.: 11/181,762

(22) Filed: Jul. 15, 2005

(30) Foreign Application Priority Data
Apr. 27, 2005 (TW) 094206604

(51) Int. Cl. E06B 9/06

(52) U.S. Cl. 160/84.06

(57) ABSTRACT

A non lift cord operated blind structure comprises a cordless blind having a set of vertical-type lateral elements symmetrically arranged to lead through passages disposed at both left and right sides of a blind body, a pair of flexibly-bound clip elements attached at both lateral bottom edges of the blind body thereon to be respectively clamped to the lateral elements thereby, and decorative covers symmetrically fixed at both ends of a headrail. Therefore, the clip elements can be directly adjusted upwards or downwards at the lateral elements thereon before clamped tight thereto to control the collection or expansion of the blind body thereby without the use of any lift cords to avoid the danger of strangling children by dangling lift cords. Besides, the decorative covers are applied to conceal the lateral elements therein, enhancing the aesthetic appeal of the cordless blind as well as achieving safer operation thereof.

### BACKGROUND OF THE INVENTION

The present invention is related to a non lift cord operated blind structure, comprising a cordless blind made up of a blind body, and a pair of flexibly-bound clip elements stably clamped at a set of lateral elements symmetrically arranged at both left and right sides of the blind body thereon wherein the clip elements can be directly adjusted upwards or downwards to control the collection or expansion of the blind body thereby without the use of any lift cords to avoid the danger of strangling children by dangling lift cords. Besides, decorative covers are provided to conceal the lateral elements therein, enhancing the aesthetic appeal of the cordless blind as well as achieving safer operation thereof.

A conventional blind structure usually found on the market is made up of a roller gear set reciprocally operated with a lift cord set and a string ladder set, which are tediously assembled in a rather time-consuming and painful manner. Besides, when the blind body thereof is raised in a collected state, the lift cord will suspend downwards and exposed outside for a certain length. As a result, children playing around can easily get caught in the dangling lift cord that, if the children are not released immediately there-from or when the lift cord is unfixed to raise upwards, can accidentally strangle and hurt the children caught therein. Thus, the conventional blinds are quite unsafe in application thereof.

### SUMMARY OF THE PRESENT INVENTION

It is, therefore, the primary purpose of the present invention to provide a non lift operated cord blind structure, comprising a cordless blind made up of a blind body, and a pair of flexibly-bound clip elements stably clamped at a set of lateral elements symmetrically arranged at both left and right sides of the blind body thereon wherein the clip elements can be directly adjusted upwards or downwards at the lateral elements thereon to control the collection or expansion of the blind body thereby without the use of any lift cords to avoid the danger of strangling children by dangling lift cords, achieving safer application of the present invention.

It is, therefore, the second purpose of the present invention to provide a non lift cord operated blind structure wherein decorative covers are provided to conceal the lateral elements therein and provide an ornamental effect thereby, enhancing the aesthetic appeal of the present invention thereof.

### BRIEF DESCRIPTION OF THE DRAWINGS

FIG. 1 is an exploded perspective view of the present invention.

FIG. 2 is an assembled perspective view of the present invention.

FIG. 3 is an assembled cross sectional view of the present invention in application.

FIG. 4 is an assembled perspective view of a clip element of the present invention in an opened-up state thereof.

FIG. 5 is an assembled cross sectional view of a blind body of the present invention in a raised-up state.

FIG. 6 is an assembled perspective view of the clip element of the present invention in a tightly-clamped state.

FIG. 7 is another diagram showing an assembled cross sectional view of the present invention in application.

FIG. 8 is an exploded perspective view of another embodiment of the present invention.

### DETAILED DESCRIPTION OF THE PREFERRED EMBODIMENTS

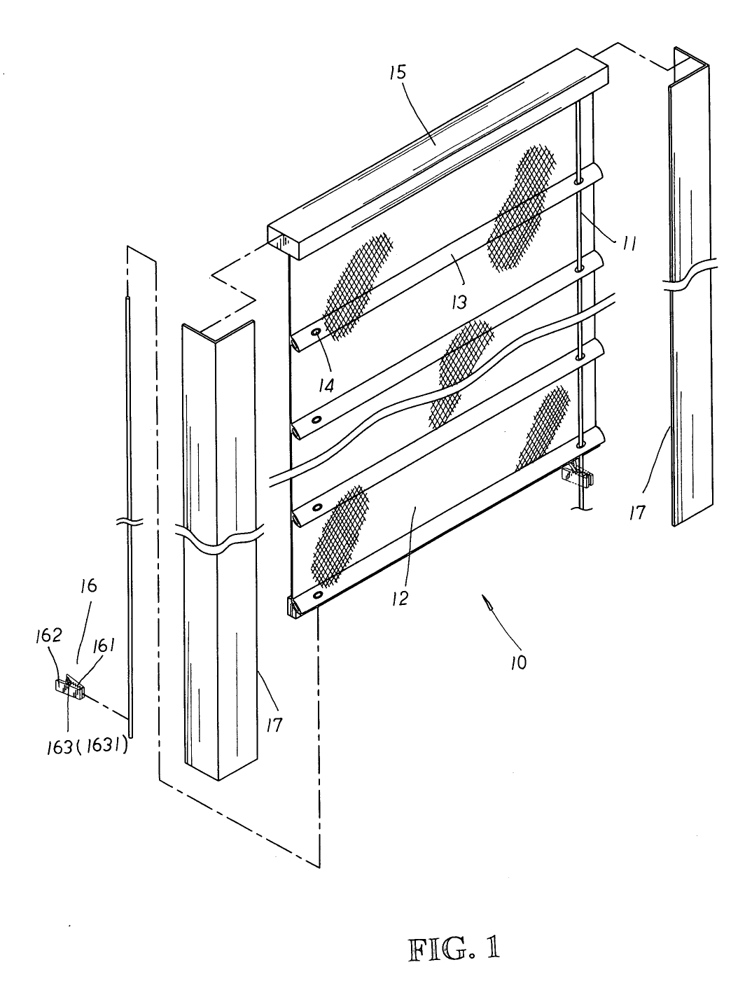

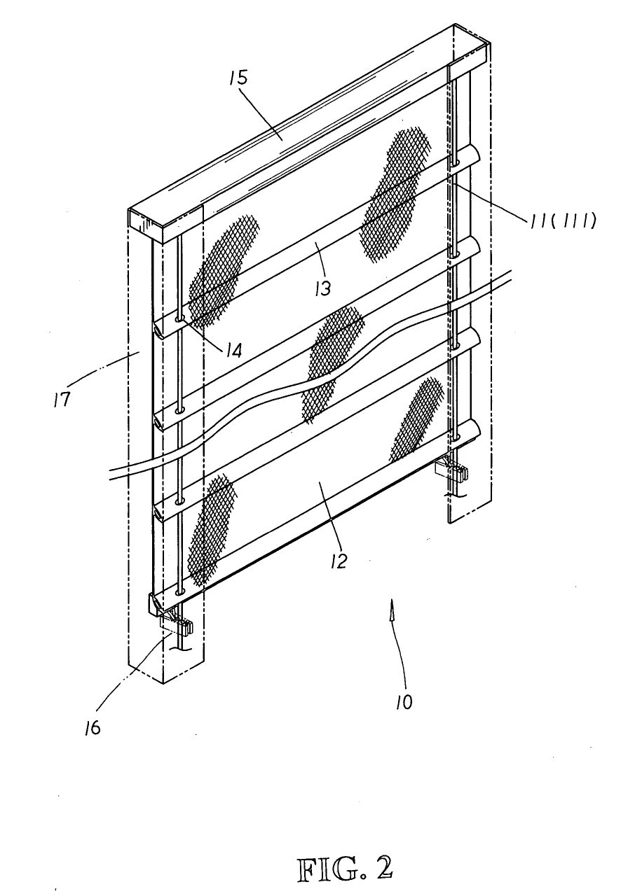

Please refer to FIG. 1 showing an exploded perspective view of the present invention (accompanied by FIG. 2 showing an assembled perspective view of the present invention). The present invention comprises a cordless blind 10 made up of a blind body 12, and a set of vertical-type lateral elements 11 (like strings or cords 111 as shown in FIGS. 1, 2) symmetrically disposed at both left and right sides thereon to be sequentially guided through passages of a plurality of elongated pieces 13 arranged in equal space at the blind body 12 thereon. At the lower ends of the lateral elements 11 are symmetrically attached a pair of clip elements 16 each having a clamping portion 161 with serrated teeth defining thereon and equipped with a flexible clamping ability via a torsional spring pivotally bound therein. The clip element 16 also has a press portion 162 symmetrically disposed at the other side thereof and a protrusive flange 163 with a thru-hole 1631 disposed thereon to be fixed at an appropriate position of the blind body 12 thereby. The upper ends of the lateral elements 11 are securely attached to an appropriate position at the underside of a headreail 15 having a pair of L-shaped lateral decorative covers 17 symmetrically fixed at both ends thereon to conceal the lateral elements 11 thereby.

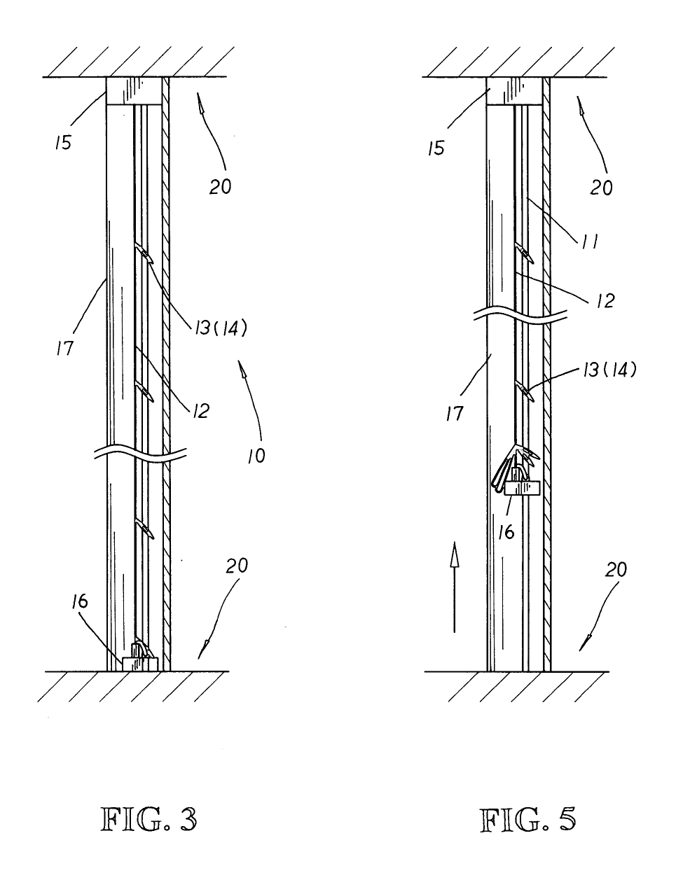

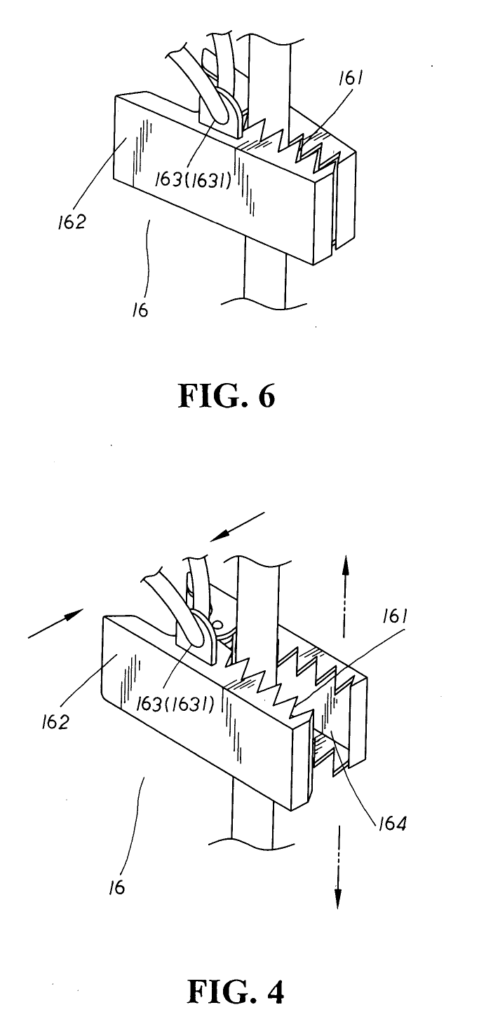

Please refer to FIG. 3. In application, the headrail 15 of the cordless blind 10 is fixed to a connecting surface 20 disposed on top, and the bottom ends of the lateral elements 11 are fixedly attached to another connecting surface 20 disposed at the bottom thereof so as to stretch upright the lateral elements 11 in the full length thereby. To collect the blind body 12 in a folded-up state, force is applied to the press portion 162 of the clip element 16 clamped at the bottom edge of the blind body 12 thereof to open up the clamping portion 161 and form a movement space 164 thereby so that the clip element 16 can be freely moved upwards as shown in FIG. 4 to bring upwards the blind body 12 therewith and sequentially fold it up in overlapped layers thereby. When the blind body 12 is collected and raised to a desired position, the press portion 162 of the clip element 16 is released from the force applied, permitting the clamping portion 161 to flexibly rebound via the torsional spring mounted therein and mesh up again so as to clamp tight against the lateral element 11 for the relocation of the raised blind body 12 collected above and limited in position by the clip element 16 thereof as shown in FIGS. 5, 6. To suspend downwards the blind body 12 in an expanded state thereof, force is applied again to the press portion 162 of the clip element 16 to open up the clamping portion 161 with the movement space 164 revealed thereby so that the clip element 16 can be moved downwards to lower the blind body 12 suspending naturally downwards in a fully-expanded state. Therefore, the cordless blind 10 of the present invention is easily and speedily operated to raise or lower the blind body 12 without the use of any lift cords to avoid the danger of strangling or hurting children due to the dangling lift cords of the conventional blind structure. Besides, the decorative covers 17 are applied to enhance aesthetic appeal of the cordless blind 10 as well as achieve safer operation thereof.

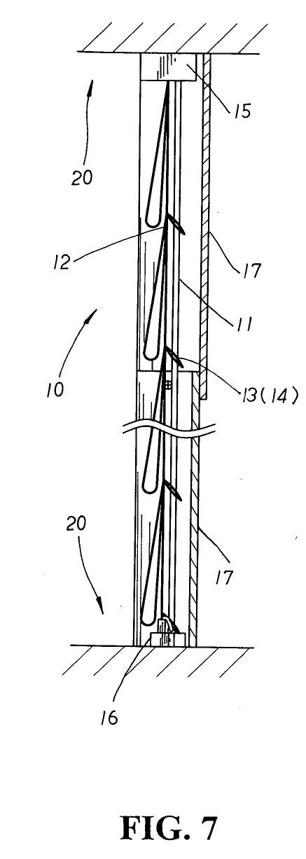

Please refer to FIG. 7. Depending on the height drawn between the top and bottom connecting surfaces 20, the decorative cover 17 can be made into multiple sections and layers that are mutually combined and fixed into one unit.

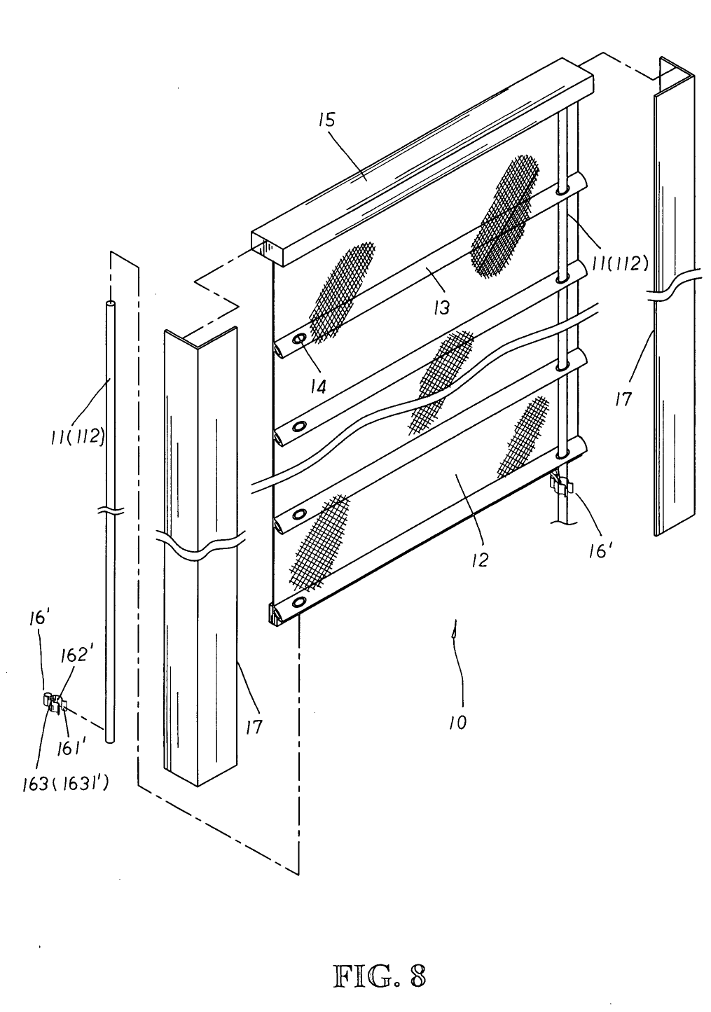

Please refer to FIG. 8 showing another embodiment of the present invention. The lateral element 11 of the cordless blind 10 can also be made in a rod body 112 guided through a flexible clip element 16′ equipped with a symmetrically-extending and resiliently-bound arcuate retaining portion 161′ and stably held in place by an accommodating space 1631′ defined by the arcuate retaining portion 161′ thereof. At the upper edge of the flexible clip element 16′ thereof is appropriately disposed a protrusive flange 163′ having a thru-hole 1631′ defining thereon to be reciprocally attached to the blind body 12 thereby.

Furthermore, the cordless blind 10 thereof can be made into various types of blinds such as the Roman blinds as shown in FIG. 1, and the hobbled Roman shades as shown in FIG. 7, etc.

What is claimed is:

1. A non lift cord operated blind structure, comprising a cordless blind made up of a blind body, a set of vertical-type lateral elements symmetrically arranged to pass through passages disposed at both left and right sides of the blind body thereon, and a pair of flexibly-bound clip elements attached at both lateral bottom edges of the blind body to be respectively clamped to the lateral elements thereby; therefore, depending on the need of a user, the clip elements can be directly adjusted upwards or downwards at the lateral elements thereon before clamped tight thereto again so as to sequentially fold up and collect the blind body above the clip element or naturally suspend the blind body downwards in fully expanded state, facilitating a convenient and speedy operation of the cordless blind to collect or expand the blind body without the use of any lift cords so as to avoid the danger of strangling children by dangling lift cords and achieve a safer application of the present invention thereby.

2. The non lift cord operated blind structure as claimed in claim 1 wherein the lateral elements thereof can be made of strings or cords thereof.

3. The non lift cord operated blind structure as claimed in claim 1 wherein the lateral elements thereof can also be made in rod bodies.

4. The non lift cord operated blind structure as claimed in claim 1 wherein the blind body of the cordless blind thereof is equipped with a plurality of elongated pieces.

5. The non lift cord operated blind structure as claimed in claim 1 wherein the clip element is symmetrically made up of a press portion, a clamping portion, and a protrusive flange.

6. The non lift cord operated blind structure as claimed in claim 1 wherein the clip element can also be made up of a retaining portion, an accommodating space, and a protrusive flange.

7. The non lift cord operated blind structure as claimed in claim 1 wherein the upper edge of the blind body is attached to a headrail.

8. The non lift cord operated blind structure as claimed in claim 5 wherein the clamping portion of the clip element is made in serrated teeth form.

9. The non lift cord operated blind structure as claimed in claim 6 wherein the retaining portion of the clip element thereof is made in an arcuate shape.

10. The non lift cord operated blind structure as claimed in claim 6 wherein the protrusive flange of the clip element thereof has a thru-hole disposed thereon to be reciprocally attached to the blind body for location thereby.

11. The non lift cord operated blind structure as claimed in claim 7 wherein the headrail thereof has a pair of decorative covers symmetrically mounted at both ends thereon.

12. The non lift cord operated blind structure as claimed in claim 11 wherein the decorative cover thereof is made in an L shape.

13. The non lift cord operated blind structure as claimed in claim 11 wherein the decorative cover thereof can also be made up of multiple sections or layers that are reciprocally combined and fixed into one unit.
